(19) United States
(12) Patent Application Publication
(10) Pub. No.: US 2006/0050513 A1
(43) Pub. Date: Mar. 9, 2006

(54) Night-vision headlamp

(75) Inventors: Ulf Georg Brauneck, Gross-Umstadt (DE); Klaus-Dieter Loosen, Mainz (DE)

Correspondence Address: Charles N. J. Ruggiero, Esq.;Ohlandt, Greeley, Ruggiero & Perle, L.L.P., 10th Floor, One Landmark Square, Stamford, CT, 06901-2682, US

(73) Assignee: Schott AG

(21) Appl. No.: 11/211,244

(22) Filed: Aug. 25, 2005

(30) Foreign Application Priority Data
Aug. 27, 2004 (DE) 10 2004 041 866.7

(51) Int. Cl. F21V 9/00

(52) U.S. Cl. 362/293; 362/510

(57) ABSTRACT

The invention relates to a headlamp having at least one broadband light source and a filter, the filter having at least a first frequency band within the near infrared wavelength region with a high transmission τ₁ preferably with τ₁>90%, and a second frequency band, which comprises the violet to red color region of the visible wavelength region, with a low transmission τ₂, in particular with τ₂<0.01%. Within the second frequency band, at least one frequency peak is located in the blue-green color region of the visible wavelength region with a transmission τₚ, where τ₂<τₚ<1%, and preferably where τ₂<τₚ<0.1%, to compensate for visible red light components.

### CROSS-REFERENCE TO RELATED APPLICATIONS

This application claims the benefit under 35 U.S.C. §119(a) of German Application No. 10 2004 041 866.7, filed Aug. 27, 2004, the entire contents of which are incorporated by reference herein.

### BACKGROUND OF THE INVENTION

1. Field of the Invention

The invention relates to a night-vision headlamp for vehicles, which includes a filter with a high transmission for the image-active IR component of a night-vision camera and a low transmission in the visible spectral region, while at the same time the color sensation of the headlamp when viewed from the front is in the ECE white region.

2. Description of Related Art

One fundamental drawback of conventional headlamp systems on vehicles is the emission of light in a frequency region which is perceptible to the human eye and in addition to the desired illumination of the area in the direction of view of the driver also blinds other road users, in particular oncoming traffic.

Attempts at solving this problem offer special reflector systems with a specific illumination characteristic which, although it improves the illumination region of the low beam further, still considerably restricts the illumination of certain regions and therefore the driver's view.

A further approach aimed at avoiding this problem is offered by night-vision systems, which emit light in the infrared region and transmit the reflective radiation to the driver as images via cameras and display systems. The image reproduction can be realized by means of a screen which is within the field of view of the driver or even using what are known as head-up displays, which project the image congruently with the outside world into the driver's eye. These systems allow maximum illumination of the viewing region and therefore provide the driver with a good view when it is dark but without blinding other road users.

Night-vision systems of this type are described, for example, in EP 0 490 029 B1, EP 0 707 424 B1 and EP 0 686 865 B1.

To illuminate the viewing region, in modern appliances near infrared (NIR) light in the wavelength range between 780 and 1000 nm is preferentially used, since the images are generally recorded using CCD or CMOS cameras by means of silicon image sensors.

The simplest designs describe additional headlamps with IR-transmitting filters in front of them arranged on the vehicle. EP 0 936 107 B1 describes an additional headlamp of this type, which emits IR radiation with a high intensity (more than 80 W/sr≅54,640 Cd) and white light with a low intensity (<60 cd), so that the latter is simultaneously also used as a position marker light. The filter is selected in such a way that it suppresses a large proportion of the visible light from the radiation source. It transmits IR and UV radiation with a high transmission and intensity and the region between visible blue and near-red radiation with a lower transmission and intensity, with the visible radiation transmitted through the filter being within the intensity permissible for position marker lights (<60 cd) and the still permissible white colorimetry. The lower the transmission in the region between visible blue and near-red radiation is set, which is necessary in order to achieve the lowest possible intensity of the light in this region, the greater the red color sensation caused by the additional headlamp, which is undesirable in this context.

If the filter is designed as a low-pass filter, which has a high transmission only in the boundary region between VIS+NIR and in the NIR, additional means, such as a further radiation source and a further filter, have to be provided in order to obtain visible radiation within the white colorimetry permissible for position marker lights.

DE 102 30 143 A1 also attempts to solve the problem of the red color sensation of IR headlamps with IR-transmitting components by superimposing white light on the red light which emerges from the filter and cannot be suppressed by the IR-transmitting filter. The IR-transmitting filter arranged in front of the lens of the headlamp is not arranged in the entire optical path, and consequently white light can emerge at least in the outer edge region of the lens, attenuating the emission of red light.

Another drawback of the above-described IR headlamps is that the vehicle requires further headlamps for the high beam and low beam and that the white light transmitted by the filter still has a relatively high intensity with a color sensation which is still red, since the visible color components in the range from 700 nm to 800 nm cannot be sufficiently suppressed.

Furthermore, there are known IR projection headlamps, based on halogen headlamps with an IR-transmitting shadowing, in which the low beam and IR high beam are realized in one component. The shadowing for setting the low beam and setting the light/dark boundary in the headlamp is intended to suppress the visible light component of the headlamp in the region of the prescribed standards, in order to avoid blinding other road users, but at the same time to allow illumination of the far viewing region with IR light.

An IR projection headlamp of this type is described in DE 100 27 018 A1. The light source is operated in modulated fashion and/or the IR light is polarized, in order to prevent the reception sensors from being blinded by other light sources. The shadowing means are opaque to visible light and transmit at least in regions of the IR wavelength region. However, headlamps of this type, on account of the high transmission of the shadowing means in the near IR, which is necessary for the CCD or CMOS sensors, have a red color sensation when seen from the front. However, transmitted radiation in the red color region of this type is disruptive to other road users, since it leads to confusion between the front and rear of a vehicle.

### BRIEF SUMMARY OF THE INVENTION

Therefore, it is an object of the invention to provide a headlamp for low beam and/or IR high beam which sufficiently restricts visible light while allowing maximum illumination of the far viewing region with IR light, while achieving a white color sensation when viewed from the front, in accordance with traffic regulations.

The object is achieved by the headlamp as claimed in claim 1, while further advantageous embodiments are described in the dependent claims.

The headlamp according to the invention comprises at least one broadband light source and a filter, the filter having at least a first frequency band within the near infrared wavelength region with a high transmission τ₁, in particular with τ₁>80% and preferably with τ₁>90%, and a second frequency band, which comprises the violet to red color region of the visible wavelength region, with a low transmission τ₂, in particular with τ₂<0.01% and preferably with τ₂<0.001%. Within the second frequency band, there is at least one frequency peak in the blue-green color region of the visible wavelength region with a transmission τₚ which is higher than the transmission of the second frequency band and a transmission which is lower than the transmission of the first frequency band, in particular with τ₂<τₚ<1% and preferably with τ₂<τₚ<0.1%.

In the context of the present invention, the term frequency peaks is to be understood as meaning transmission peaks within a frequency band.

Surprisingly, it has been found that these frequency peaks, although they have a very low transmission τₚ compared to the transmission τ₁ of the first frequency band, increase the luminous intensity of the headlamp in the visible region only to an insignificant extent and effectively compensate for the visible component of the red light, in particular from the transition region between first and second frequency bands, which forms the filter edge, and/or from the near IR region of the first frequency band, by means of additive color mixing.

It is preferable for the filter to be designed as an NIR long-pass filter, the filter edge of which, i.e. the transition region between first and second frequency bands of which, is shifted as far as possible into the IR region, in order to keep the visible component of the red light as low as possible.

The first frequency band with a high transmission τ₁ preferably comprises the wavelength range from 680 nm to 1200 nm, preferably from 780 nm to 1200 nm, which is sensitive for IR sensors, such as for example CCD or CMOS sensors, in particular if the headlamp is used as an IR headlamp in a night-vision device.

The second frequency band, which has a very low transmission τ₂, comprises in particular at least the wavelength range from 400 nm to 680 nm, preferably from 400 nm to 780 nm. Visible light is as far as possible absorbed and/or reflected within the second frequency band.

In a further advantageous configuration of the invention, the filter has at least a third frequency band within the ultraviolet wavelength region (<380 nm) with a transmission τ₃>0.1%, preferably τ₃>1%, and particularly preferably 10%<τ₃<100%.

At least one frequency peak preferably lies in the wavelength range between 450 and 550 nm, with the precise number, position, width and height of the frequency peaks depending on the particular profile (wavelength regions, transmission values, filter edge(s), etc.) of the frequency bands.

The frequency bands and the frequency peak(s) are preferably configured in such a manner that the visible light which emerges from the filter is white in color.

If the headlamp is to be used for a vehicle, the ECE standard values for white light which are predetermined in accordance with traffic regulations are to be complied with. In accordance with the ECE regulations, the color features of the visible light of white color, expressed in chromaticity coordinates of the CIE 1931 standard chromaticity diagram, must be within the following limits:

| | |
|---|---|
| limit with respect to blue | x ≧ 0.310 |
| limit with respect to yellow | x ≦ 0.500 |
| limit with respect to green | y ≦ 0.150 + 0.640*x; |
| | y ≦ 0.440 |
| limit with respect to purple | y ≧ 0.050 + 0.750*x |
| limit with respect to red | y ≧ 0.382 |

The frequency bands and the frequency peak(s) of the filters for motor vehicle headlamps are therefore preferably configured in such a manner that the visible light of white color which emerges from the filter is within the ECE standard values.

According to an advantageous configuration of the invention, the visible light which emerges from the filter and therefore from the region of the headlamp which is covered by the filter in particular has a luminous intensity of less than 100 cd, preferably of less than 60 cd and particularly preferably of less than 30 cd, and the IR light which emerges is more than 80%, preferably more than 90%, transmitted IR light from the light source, so that the filter can be used for a headlamp for illuminating a far viewing area of a motor vehicle. The far viewing area is illuminated with IR light of sufficient intensity, with a headlamp of this type being designed as part of a night-vision device. At the same time, the visible component of the light is of a low intensity and white in color, so that other road users cannot be blinded or irritated by a red color sensation of the headlamp.

The arrangement of the filter in the beam path of the headlamp determines the way in which the latter functions. For example, in a headlamp which functions exclusively as an IR headlamp, for example for a night vision device, the filter is arranged in a fixed position in the beam path of the headlamp, in particular in such a manner that the filter covers the entire light emergence region of the headlamp.

In further advantageous configurations of the invention, the position of the filter can be variably adjusted with respect to the beam path of the headlamp, and in particular the filter can be pivoted into the beam path of the headlamp.

This allows the headlamp to be set to at least two operating modes.

It is preferable for the filter to be arranged fixedly or pivotably in the beam path of the headlamp, in such a manner that the filter covers a high beam region of the light emergence region of the headlamp and/or leaves clear a low beam region of the light emergence region of the headlamp. This allows the IR headlamp to be simultaneously used as a headlamp for the low beam.

It is preferable for the filter of the headlamp to comprise an interference filter, in particular an interference layer system applied to a transparent substrate, for example glass, in which case the interference layer system preferably comprises layers applied by means of ion-assisted evaporation coating. Layer systems of this type are distinguished by a high optical quality and stability.

The layer materials and the process parameters are in particular selected in such a way that the filter is thermally stable at least up to 400° C. and is therefore able to withstand thermal loading from the light source.

The light source of the headlamp is a broadband light source, in particular a halogen lamp, and preferably emits light in the wavelength range from 200 nm to 2000 nm.

A further advantageous configuration of the headlamp comprises the headlamp being designed as a reflector headlamp. For this purpose, the headlamp body is designed as a reflector or at least one reflector is arranged in the headlamp, diverting the light emitted from the light source as a substantially parallel light beam to the light emergence region of the headlamp.

In particular in the case of the embodiment of the filter in the form of an interference filter, on account of the dependency of the filter action on the optical path length of the light, it is advantageous if the angle of incidence of the light which impinges on the filter varies by less than 25°, preferably less than 10°, i.e. a light beam which is as parallel as possible impinges on the filter and/or the angle of the filter with respect to the optical axis of the light beam does not vary much.

The invention is to be explained in more detail below on the basis of exemplary embodiments.

### BRIEF DESCRIPTION OF THE SEVERAL VIEWS OF THE DRAWINGS

FIG. 1 shows a diagrammatic excerpt from the CIE 1931 chromaticity diagram with the ECE white light region marked,

FIG. 2 shows the filter characteristic curve for exemplary embodiment A, and

FIG. 3 shows the filter characteristic curve for exemplary embodiment B.

### DETAILED DESCRIPTION OF THE INVENTION

### Exemplary Embodiment A

The headlamp is designed as a low beam reflector headlamp with a filter which can be pivoted in and a halogen lamp as light source. The angle of incidence of the light impinging on the filter is 20° and can vary by ±10°.

The filter comprises a 3 mm thick glass substrate with an interference layer system applied by evaporation coating and comprising 60 silicon oxide and titanium oxide layers with a structure corresponding to that presented in Table 1.

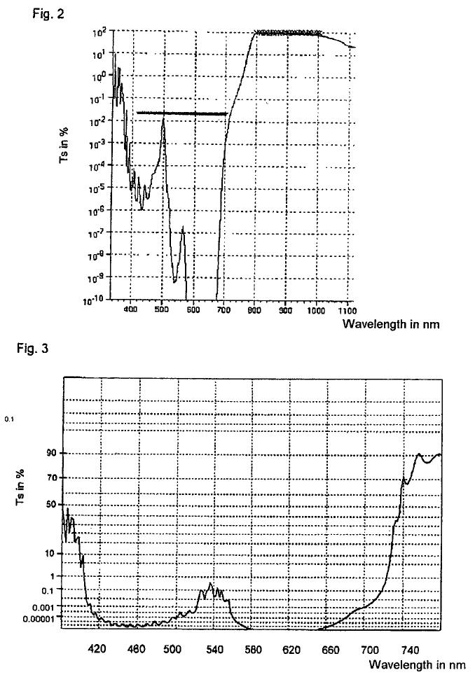

As illustrated in FIG. 2, the filter has a first frequency band in the IR range from approx. 800 nm to 1000 nm with a high transmission of between 90 and 100%. The second frequency band in the visible range of light from approx. 380 nm to 680 nm has a very low transmission of less than 0.0001% and at least one frequency peak in the blue-green region of the visible light at approx. 500 nm with a transmission of approx. 0.01%.

The color of the light which emerges from the filter is in the ECE white region at x=0.3313 and y=0.3102 and has a luminous intensity of <1 cd.

The headlamp in accordance with Exemplary Embodiment A is suitable as a low beam headlamp and simultaneously serves as a signal transmitter for a night vision device.

TABLE 1
Substrate

| | | | |
|---|---|---|---|
| 1. | TiO₂ layer | 31.16 | nm |
| 2. | SiO₂ layer | 49.39 | nm |
| 3. | TiO₂ layer | 91.99 | nm |
| 4. | SiO₂ layer | 41.19 | nm |
| 5. | TiO₂ layer | 43.23 | nm |
| 6. | SiO₂ layer | 77.21 | nm |
| 7. | TiO₂ layer | 27.56 | nm |
| 8. | SiO₂ layer | 75.72 | nm |
| 9. | TiO₂ layer | 40.98 | nm |
| 10. | SiO₂ layer | 64.17 | nm |
| 11. | TiO₂ layer | 43.69 | nm |
| 12. | SiO₂ layer | 68.40 | nm |
| 13. | TiO₂ layer | 43.69 | nm |
| 14. | SiO₂ layer | 68.40 | nm |
| 15. | TiO₂ layer | 43.69 | nm |
| 16. | SiO₂ layer | 68.40 | nm |
| 17. | TiO₂ layer | 43.69 | nm |
| 18. | SiO₂ layer | 68.40 | nm |
| 19. | TiO₂ layer | 43.69 | nm |
| 20. | SiO₂ layer | 68.40 | nm |
| 21. | TiO₂ layer | 43.69 | nm |
| 22. | SiO₂ layer | 68.40 | nm |
| 23. | TiO₂ layer | 43.69 | nm |
| 24. | SiO₂ layer | 68.40 | nm |
| 25. | TiO₂ layer | 43.69 | nm |
| 26. | SiO₂ layer | 68.40 | nm |
| 27. | TiO₂ layer | 34.11 | nm |
| 28. | SiO₂ layer | 66.06 | nm |
| 29. | TiO₂ layer | 47.12 | nm |
| 30. | SiO₂ layer | 98.09 | nm |
| 31. | TiO₂ layer | 36.62 | nm |
| 32. | SiO₂ layer | 55.91 | nm |
| 33. | TiO₂ layer | 32.58 | nm |
| 34. | SiO₂ layer | 95.51 | nm |
| 35. | TiO₂ layer | 35.80 | nm |
| 36. | SiO₂ layer | 232.30 | nm |
| 37. | TiO₂ layer | 37.97 | nm |
| 38. | SiO₂ layer | 110.14 | nm |
| 39. | TiO₂ layer | 74.06 | nm |
| 40. | SiO₂ layer | 110.14 | nm |
| 41. | TiO₂ layer | 74.06 | nm |
| 42. | SiO₂ layer | 110.14 | nm |
| 43. | TiO₂ layer | 74.06 | nm |
| 44. | SiO₂ layer | 110.14 | nm |
| 45. | TiO₂ layer | 74.06 | nm |
| 46. | SiO₂ layer | 110.14 | nm |
| 47. | TiO₂ layer | 74.06 | nm |
| 48. | SiO₂ layer | 110.14 | nm |
| 49. | TiO₂ layer | 74.06 | nm |
| 50. | SiO₂ layer | 110.14 | nm |
| 51. | TiO₂ layer | 74.06 | nm |
| 52. | SiO₂ layer | 110.14 | nm |
| 53. | TiO₂ layer | 74.06 | nm |
| 54. | SiO₂ layer | 110.14 | nm |
| 55. | TiO₂ layer | 43.63 | nm |
| 56. | SiO₂ layer | 182.10 | nm |
| 57. | TiO₂ layer | 40.91 | nm |
| 58. | SiO₂ layer | 59.80 | nm |
| 59. | TiO₂ layer | 6.81 | nm |
| 60. | SiO₂ layer | 158.05 | nm |

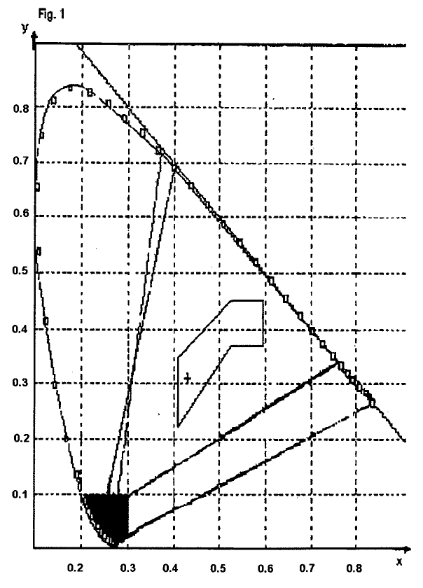

The ECE white region is marked in FIG. 1 in a CIE 1931 chromaticity diagram and lies within the following limits:

| | |
|---|---|
| limit with respect to blue | x ≧ 0.310 |
| limit with respect to yellow | x ≦ 0.500 |
| limit with respect to green | y ≦ 0.150 + 0.640*x; |
| | y ≦ 0.440 |
| limit with respect to purple | y ≧ 0.050 + 0.750*x |
| limit with respect to red | y ≧ 0.382 |

### Exemplary Embodiment B

The headlamp is designed as a low beam reflector headlamp with a filter that can be pivoted in and a halogen lamp as light source. The angle of incidence of the light impinging on the filter is 20° and may vary by ±1°.

The filter comprises a 1 mm thick glass substrate with an interference layer system which is applied by evaporation coating and comprises 107 silicon oxide and titanium oxide layers with the following structure:
Substrate/0.35H/0.7L/21(0.7H/0.7L)/0.8H/0.8L/8(0.92H/0.92L)/0.95L/21(H/L)/0.5H, where
H is a layer of TiO₂ with an optical thickness of λ/4 at 642 nm, and
L is a layer of SiO₂ with an optical thickness of λ/4 at 642 nm.

The filter is a long-pass filter and, as illustrated in FIG. 3, has a first frequency band in the IR range from approx. 750 nm to 1200 nm with a high transmission of between 85% and 100%. The second frequency band in the visible range of light from approx. 420 nm to 680 nm has a very low transmission of less than 0.001% and at least one frequency peak with a selective transmission in the blue-green spectral range at approx. 520 to 560 nm of approx. 0.01% to 1%.

The filter design, configured for an angle of incidence of the radiation of 20°, together with the angle distribution of the radiation impinging on the filter, which is effectively caused by the reflector, leads to a luminous color emitted by the headlamp as a whole which lies in the ECE white region. The luminous intensity is <10 cd.

The headlamp in accordance with Exemplary Embodiment B is suitable as a low beam headlamp and simultaneously serves as a signal transmitter for a night-vision device.

Key to Figures:

1. Wavelength in nm
2. 0.1
3. 0.001
4. 0.00001

1. A headlamp comprising:
at least one broadband light source; and
a filter, the filter at least having
a first frequency band within the near infrared wavelength region with a high first transmission, and
a second frequency band from the violet to red color region of the visible wavelength region with a low second transmission and with at least one frequency peak in the blue-green color region of the visible wavelength region with a peak transmission greater than the second transmission.

2. The headlamp as claimed in claim 1, wherein the first transmission is greater than 80%.

3. The headlamp as claimed in claim 1, wherein the second transmission is less than 0.01%.

4. The headlamp as claimed in claim 1, wherein the peak transmission is greater than the second transmission and less than 1%.

5. The headlamp as claimed in claim 1, wherein the filter is an NIR long-pass filter.

6. The headlamp as claimed in claim 1, wherein the first frequency band comprises the wavelength range from 680 nm to 1200 nm.

7. The headlamp as claimed in claim 1, wherein the second frequency band comprises at least the wavelength range from 400 nm to 700 nm.

8. The headlamp as claimed in claim 1, wherein at least one frequency peak lies in the wavelength range between 450 and 550 nm.

9. The headlamp as claimed in claim 1, wherein the filter has at least a third frequency band within the ultraviolet wavelength region with a third transmission less than 0.1%.

10. The headlamp as claimed in claim 1, wherein visible light which emerges from the filter is white in color.

11. The headlamp as claimed in claim 10, wherein the color features of the visible light, expressed in chromaticity coordinates of the CIE 1931 standard chromaticity diagram, are within the following limits:

| | |
|---|---|
| limit with respect to blue | x ≧ 0.310, |
| limit with respect to yellow | x ≦ 0.500, |
| limit with respect to green | y ≦ 0.150 + 0.640*x; y ≦ 0.440, |
| limit with respect to purple | y ≧ 0.050 + 0.750*x, and |
| limit with respect to red | y ≧ 0.382. |

12. The headlamp as claimed in claim 1, wherein visible light which emerges from the filter has a luminous intensity of less than 100 cd.

13. The headlamp as claimed in claim 1, wherein the IR light which emerges from the filter is more than 80%, transmitted IR light from the at least one broadband light source.

14. The headlamp as claimed in claim 1, wherein the filter is arranged in a fixed position in a beam path of the headlamp.

15. The headlamp as claimed in claim 14, wherein the filter covers an entire light emergence region of the headlamp.

16. The headlamp as claimed in claim 1, wherein the filter can be variably positioned with respect to a beam path of the headlamp.

17. The headlamp as claimed in claim 16, wherein the filter can be pivoted into the beam path of the headlamp.

18. The headlamp as claimed in claim 16, wherein the filter covers a high-beam region of a light emergence region of the headlamp.

19. The headlamp as claimed in claim 18, wherein the filter leaves clear a low beam region of the light emergence region of the headlamp.

20. The headlamp as claimed in claim 1, wherein the filter comprises an interference filter.

21. The headlamp as claimed in claim 20, wherein the filter comprises a glass with an interference layer system.

22. The headlamp as claimed in claim 21, wherein the interference layer system comprises layers applied by ion-assisted evaporation coating.

23. The headlamp as claimed in claim 1, wherein the filter is thermally stable up to at least 400° C.

24. The headlamp as claimed in claim 1, wherein the at least one broadband light source emits light in the wavelength range from 200 nm to 2000 nm.

25. The headlamp as claimed in claim 24, wherein the at least one broadband light source is a halogen lamp.

26. The headlamp as claimed in claim 1, further comprising at least one reflector so that the headlamp is designed as a reflector headlamp.

27. The headlamp as claimed in claim 26, wherein the at least one broadband light source emits light which impinges on the filter with an angle of incidence and wherein the angle of incidence of the light which impinges on the filter varies by less than 25°.

28. An IR transmission filter, comprising:
at least a first frequency band within the near infrared wavelength region with a first transmission greater than 80%, and
a second frequency band, which comprises the violet to red color region of the visible wavelength region, with a second transmission less than 0.01%, at least one frequency peak within the second frequency band being located in the blue-green color region of the visible wavelength region with a peak transmission that is higher than the second transmission, lower than the first transmission, and lower than 1%.
